(19) United States
(12) Patent Application Publication
(10) Pub. No.: US 2011/0135956 A1
(43) Pub. Date: Jun. 9, 2011

(54) METHOD OF JOINING MATERIALS, AND ARTICLES MADE THEREWITH

(75) Inventors: Satish Sivarama Gunturi, Albany, NY (US); Thomas Carson Tiearney, JR., Waukesha, WI (US); Kristopher John Frutschy, Clifton Park, NY (US); Dalong Zhong, Niskayuna, NY (US); Xi Zhang, Ballston Lake, NY (US)

(73) Assignee: GENERAL ELECTRIC COMPANY, SCHENECTADY, NY (US)

(21) Appl. No.: 12/632,852

(22) Filed: Dec. 8, 2009

(51) Int. Cl. B32B 15/01; B29C 65/00; B23K 31/02; B29C 65/02

(52) U.S. Cl. 428/660; 156/60; 228/175

(57) ABSTRACT

A method of joining a first component and a second component is provided. The first component has a surface that comprises at least about 75% by volume of a refractory metal. The second component has a coefficient of thermal expansion greater than a coefficient of thermal expansion of the first component. The method includes disposing a coating on the surface of the first component. The coating includes an adhesion layer and a wetting layer disposed over the adhesion layer. The method further includes disposing a bonding material between the first and second components and joining them. The bonding material has a melting temperature lower than a melting temperature of the second component. An article made using the method is also presented.

### BACKGROUND

The invention relates generally to the joining of refractory metals or alloys to materials having relatively high thermal expansion coefficients. More particularly, the invention relates to the joining of such materials at low temperatures. The invention also relates articles formed using such joining methods.

There are various applications where it is desirable to attach a refractory body to, for instance, a thermally conductive metallic substrate to create an effective joint that will remain satisfactory for extended periods in a high temperature environment, such as above 1000 degrees Celsius, and in certain instances above 1500 degrees Celsius, or even above 2000 degrees Celsius.

One use of such structures is in the field of stationary anode x-ray tubes. Typically, x-ray tubes include an anode structure comprising a target onto which the electron beam impinges to generate x-rays. An x-ray tube cathode provides a focused electron beam that is accelerated across a cathode-to-anode vacuum gap and produces x-rays upon impact with the anode target. The anode target, generally, includes a refractory metal or a refractory metal alloy. Various methods have been developed to manage the thermal load imposed on the anode assembly by the impinging electron beam. In one method, the target is rotated at high speed to distribute heat along a track. In stationary anode designs, on the other hand, a heat sink of high thermal conductivity material is typically used as an anode base and the anode target is bonded to a surface of the anode base.

Bonding the anode target to a thermally conductive heat sink is usually accomplished by brazing. Brazing aids the conduction of heat away from the anode target to the heat sink due to lower thermal resistance of the brazed interface relative to a dry interface. However, it is difficult to braze the target anode to the heat sink because oxide formation at the target anode surface may create problems with adhesion of the braze to the anode. Moreover, conventional brazing, which is performed at relatively high temperatures, may cause warping and cracking at the braze interface and the heat sink because of significant interfacial stresses due to CTE (coefficient of thermal expansion) mismatch between the refractory material and the heat sink material.

Thus, there is a need to provide an improved method of joining a refractory metal or a refractory metal alloy to a material having a relatively high CTE, such as a thermally conductive material.

### BRIEF DESCRIPTION

One embodiment is a method comprises providing a first component, a second component and joining the first component and the second component. The first component has a surface that comprises at least about 75% by volume of a refractory metal. The second component has a coefficient of thermal expansion greater than a coefficient of thermal expansion of the first component. The method includes disposing a coating on the surface of the first component. The coating includes an adhesion layer and a wetting layer. The wetting layer is disposed over the adhesion layer. The method further includes disposing a bonding material between the first and second components and joining them. The bonding material has a melting temperature lower than a melting temperature of the second component.

Another embodiment is an article comprising a first component, a second component and a bonding material disposed between the first component and the second component. The first component has a surface that comprises at least about 75% by volume of a refractory metal. A coating is disposed on the surface of the first component. The coating comprises an adhesion layer comprising chromium and a wetting layer comprising nickel. The wetting layer is disposed over the adhesion layer. The second component has a coefficient of thermal expansion greater than a coefficient of thermal expansion of the first component. The bonding material has a melting temperature lower than a melting temperature of the second component.

### DRAWINGS

These and other features, aspects, and advantages of the present invention will become better understood when the following detailed description is read with reference to the accompanying drawing in which like characters represent like parts throughout the drawings, wherein:

FIG. 1 is a schematic of cross section of a device in accordance with one embodiment of the present invention.

FIG. 2 is a schematic of cross section of a device in accordance with one embodiment of the present invention.

FIG. 3 is a schematic of cross section of a device in accordance with one embodiment of the present invention.

### DETAILED DESCRIPTION

As discussed in detail below, embodiments of the present invention include methods for joining a refractory metal or alloy with a material having a relatively high CTE, such as a thermally conductive material and articles made using such methods. Moreover, illustrative embodiments of the invention will be described with respect to use in an x-ray tube. However, one skilled in the art will appreciate that the descriptions are applicable for other systems that include joining of such components.

Approximating language, as used herein throughout the specification and claims, may be applied to modify any quantitative representation that could permissibly vary, without resulting in a change in the basic function to which it is related. Accordingly, a value modified by a term or terms, such as “about”, is not limited to the precise value specified. In some instances, the approximating language may correspond to the precision of an instrument for measuring the value.

In the following specification and the claims that follow, the singular forms “a”, “an” and “the” include plural referents unless the context clearly dictates otherwise.

Embodiments of the invention include a method of joining a first component and a second component. The first component has a surface having at least about 75% by volume of a refractory metal. The second component has a coefficient of thermal expansion similar to or greater than that of the first component. In exemplary embodiments, the first component is an x-ray target and the second component is a heat sink for the target.

Joining the first component and the second component by a conventional technique, for example brazing, is usually achieved at high temperatures, that is, greater than about 1000 degrees Celsius. High temperature bonding or brazing may cause damage of the second component, the first component and bonding interfaces due to expansion and contraction during joining. Thus, it is advantageous to join the first and the second components at relatively low temperatures. Low temperature brazing or bonding is achievable but generally is hampered by an oxide layer at the surface of the first component; this oxide layer is usually naturally removed during high temperature joining Embodiments of the present invention advantageously avoid the risk of damaging the joint by joining the two components at relatively lower temperatures.

According to embodiments of the invention, the method includes the steps of disposing a coating on the surface of the first component and disposing a bonding material between the first component and the second component for joining the first and the second components. The coating of the first component includes an adhesion layer and a wetting layer disposed over the adhesion layer. The bonding material has a melting temperature lower than a melting temperature of the second component.

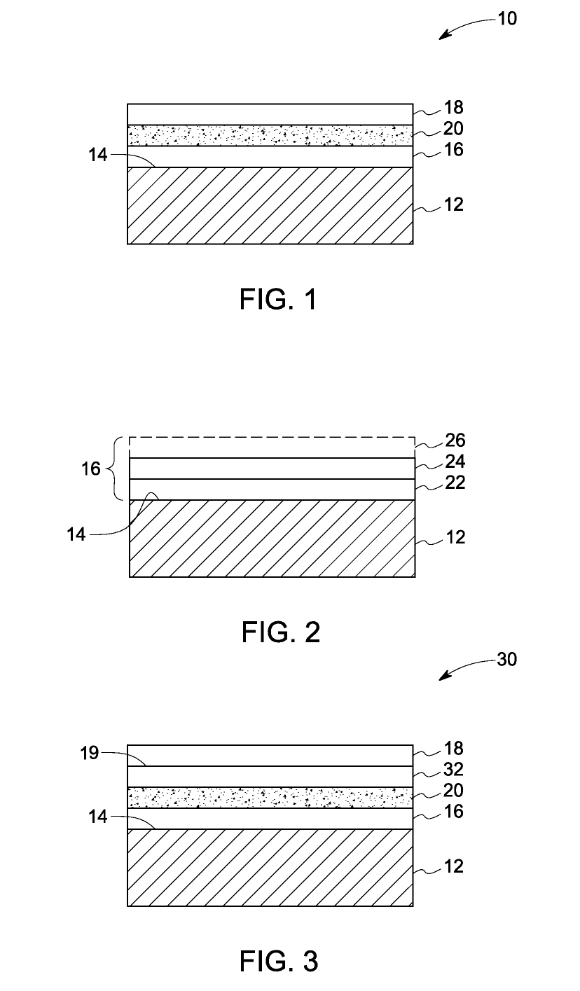

FIG. 1 illustrates a schematic of an article 10 according to an embodiment of the invention. The article 10 includes a first component 12 and a second component 18. The first component 12 has a surface 14 containing at least about 75% by volume of a refractory metal. A coating 16 is disposed on the surface 14 of the first component. The article 10 further includes a bonding material 20 disposed between the first component and the second component.

In some embodiments, the first component 12 includes a refractory metal selected from the group consisting of tungsten, molybdenum, rhenium, tantalum, niobium, zirconium, titanium or a combination thereof. In certain embodiments, the first component includes an alloy of tungsten and molybdenum, an alloy of tungsten and rhenium, an alloy of molybdenum and titanium or an alloy of molybdenum and rhenium. In one embodiment, the first component includes an alloy of titanium, zirconium and molybdenum (TZM). Moreover, in some embodiments, the amount of the refractory metal present at the surface 14 of the first component 12 is greater than about 75% by volume, and in some specific embodiments, greater than about 80% by volume.

In one embodiment, the second component 18 has a coefficient of thermal expansion greater than a coefficient of thermal expansion of the first component 14. In another embodiment, the second component has a coefficient of thermal expansion greater than about 5 ppm/K, and in certain embodiments, greater than about 10 ppm/K. The second component 18 includes a metal. Non-limiting examples of metals suitable for the second component include copper, silver, gold, nickel, iron, aluminum or an alloy comprising any of these metals. In one embodiment, the second component is made of one or more of the metals. In another embodiment, the second component includes a metal matrix composite having the metal or the metal alloy and reinforced by, for example, carbon, a ceramic, or an inorganic material.

As discussed above, to protect the surface 14 of the first component 12 from oxide formation, the surface is coated with a coating 16. According to embodiments of the invention, the coating 16 includes an adhesion layer 22 and a wetting layer 24 as illustrated in FIG. 2. The adhesion layer 22 is disposed on the surface 14 of the first component 12 and the wetting layer 24 is disposed over the adhesion layer 22.

The wetting layer 24 promotes joining to the bonding material 20 by chemical reaction and/or diffusion process as well as protects the surface 14 of the first component 12 from oxide formation. In one embodiment, the wetting layer includes a metal such as nickel, silver, gold or copper. In some instances, the thickness of the wetting layer is in a range from about 0.02 micron to about 100 microns, and in some specific instances, from about 1 micron to about 20 microns.

The adhesion layer 22 is disposed over the surface 14 of the first component 12 for better adhesion of the wetting layer 24 to the surface 14. In some embodiments, the adhesion layer includes a metal selected from the group consisting of chromium (Cr), titanium (Ti), tungsten (W), molybdenum (Mo) or a combination thereof. The thickness of the adhesion layer varies from about 0.01 micron to about 20 microns. In certain embodiments, the thickness of the adhesion layer is in a range from about 0.05 micron to about 1 micron.

In some embodiments, the coating 16 further includes a barrier layer 26. The bather layer 26 is disposed over the wetting layer 24 to protect the wetting layer 24 from surrounding atmosphere. The bather layer may include a metal such as gold, silver, or platinum. Thickness of the bather layer 26 may be as required to protect the wetting layer 24. In one embodiment, the thickness of the barrier layer 26 may be within a range from about 0.01 micron to about 0.5 microns.

The second component may or may not be coated with a coating. Such an embodiment is illustrated in FIG. 3. An article 30 includes a first component 12 and a second component 18. The first component 12 has a surface 14 containing at least about 75% by volume of a refractory metal. A coating 16 is disposed on the surface 14 of the first component. A surface 19 of the second component 18 is coated with a coating 32 similar to the coating 16. The article 30 further includes a bonding material 20 disposed between the first component and the second component.

Various techniques may be used to deposit the coating 16 on a surface. Non-limiting examples of suitable deposition techniques may include electro-plating, electroless plating, physical vapor deposition, chemical vapor deposition, thermal spraying and plasma spraying.

According to an embodiment of the invention, joining of the first component and the second component occurs at relatively low temperature. The relative lowering of the joining temperature depends on the bonding material disposed between the first and the second components and the technique used for joining. In one embodiment, the joining of the two components may be carried out in a temperature range from about 200 degrees Celsius to about 1000 degrees Celsius. In another embodiment, the joining of the two components may be carried out in a temperature range from about 400 degrees Celsius to about 800 degrees Celsius. In some instances, the joining temperature can be as low as possible depending on the bonding material.

The bonding material may be a metallic material. Suitable metals as bonding material include, but are not limited to, one or more of silver, gold, copper, nickel, aluminum, indium, titanium, zirconium. In some embodiments, the bonding material has a melting temperature lower than a melting temperature of the second component. In some other embodiments, the bonding material has a melting temperature as low as possible for joining the first component and the second component to avoid warping and cracking. In some embodiments, a single metal element may be used as the bonding material. In these instances, the melting temperature of the bonding material may be less than about 1000 degrees Celsius. Moreover, an alloy having at least two metals may be used as the bonding material, in some embodiments. The melting temperature of the alloys may be less than about 800 degrees Celsius, in these instances, and may be less than about 750 degrees Celsius, in certain instances.

Various joining techniques may be used for joining the first component and the second component. Suitable joining techniques include, but are not limited to, brazing, silver or gold bonding, reactive joining, and a combination of two or more thereof.

Brazing is a metal-joining process where the bonding material is heated to melting temperature and distributed between the two or more close fitting components by capillary action. Brazing may be carried out in vacuum or in a protective atmosphere containing an inert gas and at a temperature depending on the melting temperature of the bonding material. Typically, bonding materials having high melting temperatures are used for brazing.

According to some embodiments of the invention, bonding materials having low melting temperatures may be used for brazing. In some instances, bonding materials having melting temperatures as low as possible, yet compatible with high vacuum operation may be used. Suitable examples of such bonding materials are, but not limited to, metal alloys including two or more metals of silver, indium, copper, titanium or zirconium. One such example is INCUSIL 15, which has a melting temperature of 715 degrees Celsius. In some embodiments, brazing may be carried out in a temperature range from about 500 degrees Celsius to about 1000 degrees Celsius, and in certain embodiments, from about 600 degrees Celsius to about 800 degrees Celsius.

In some embodiments, silver or gold bonding technique may be used to join the first component and the second component. A slurry of silver or gold (metal powder mixed with organic solvent) is applied to the surfaces, of the first component and the second component, to be joined. Any suitable technique such as spraying or screen-printing may be used. Bonding/joining of the two components may be carried out by simultaneously heating and pressing the two components together and is obtained by solid-state diffusion without bulk melting of the powder particles of silver or gold. The advantage of using this joining technique is that even the melting temperature of the bonding material are high, 960 degrees Celsius for silver and 1064 degrees Celsius for gold, however the bonding may be carried out by heating at much lower temperature, for example, about 250 degrees Celsius or above depending on the applied pressure and time to join the components. In certain instances, the bonding may be carried out by heating at a temperature in a range from about 200 degrees Celsius to about 350 degrees Celsius.

Reactive joining is a well-known process and is also known as reactive multilayer joining Reactive joining generally employs multilayer films as a local heat source through an exothermic reaction between the layers to melt and flow an adjacent braze alloy to form a joint between two components. A reactive multilayer film typically contains nano-scale laminates of tens or hundreds of individual layers of two or more reactants having large negative enthalpy of formation. Some examples of reactants are nickel-aluminum, nickel-titanium, titanium-aluminum, titanium-carbon, zirconium-carbon and nickel-titanium-carbon. The reactive multilayer film may be ignited by an energy source to initiate and propagate the exothermic reaction, which melts the braze alloy to form a joint. The reactive multilayer film may be disposed on the first component, the second component, or both components. The two components may be joined together by simultaneously pressing them together and igniting the reactive multilayer film/films between them. The advantage of using reactive joining is that joining of the two components can be carried out at low temperature, possibly even at room temperature, depending on the bonding material.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method, comprising:
providing a first component having a surface that comprises at least about 75% by volume of a refractory metal;
disposing a coating on the surface of the first component, wherein the coating comprises an adhesion layer and a wetting layer disposed over the adhesion layer;
providing a second component having a coefficient of thermal expansion greater than a coefficient of thermal expansion of the first component;
disposing a bonding material between the first and second components, wherein the bonding material has a melting temperature lower than a melting temperature of the second component; and
joining the first and second components.

2. The method of claim 1, wherein the refractory metal comprises at least one selected from the group consisting of W, Mo, Re, Ta, Nb, Zr, TZM, and alloys thereof.

3. The method of claim 1, wherein the second component comprises a metal selected from the group consisting of Cu, Ag, Au, Ni, Fe, Al, alloys comprising one of these, and composites comprising one or more of these.

4. The method of claim 1, wherein the second component has a coefficient of thermal expansion greater than about 5 ppm/K.

5. The method of claim 1, wherein the second component has a coefficient of thermal expansion greater than about 10 ppm/K.

6. The method of claim 1, wherein the adhesion layer is disposed on the surface of the first component.

7. The method of claim 1, wherein the coating comprises a barrier layer disposed over the wetting layer.

8. The method of claim 1, wherein the adhesion layer comprises a metal selected from the group consisting of chromium (Cr), titanium (Ti), tungsten (W), molybdenum (Mo) or a combination thereof.

9. The method of claim 1, wherein the thickness of the adhesion layer is in a range from about 0.01 micrometers to about 20 micrometers.

10. The method of claim 1, wherein the wetting layer comprises a metal selected from the group consisting of nickel (Ni), silver (Ag), gold (Au), and copper (Cu).

11. The method of claim 1, wherein the thickness of the wetting layer is in a range from about 0.02 micrometers to about 100 micrometers.

12. The method of claim 7, wherein the barrier layer comprises a metal selected from the group consisting of gold, silver, and platinum.

13. The method of claim 7, wherein the thickness of the barrier layer is in a range from about 0.01 micrometers to about 0.5 micrometers.

14. The method of claim 1, wherein the melting temperature of the bonding material is less than about 800 degree Celsius.

15. The method of claim 1, wherein the melting temperature of the bonding material is less than about 1200 degree Celsius.

16. The method of claim 1, wherein the bonding material comprises a metallic material.

17. The method of claim 15, wherein the metallic material comprises at least one of silver, gold, nickel, aluminum, copper, indium, titanium or zirconium.

18. The method of claim 1, wherein joining comprises brazing.

19. The method of claim 17, wherein brazing is carried out at a temperature in a range from about 500 degrees Celsius to about 1000 degrees Celsius.

20. The method of claim 1, wherein joining comprises silver or gold bonding.

21. The method of claim 19, wherein bonding is carried out at a temperature in a range from about 200 degrees Celsius to about 350 degrees Celsius.

22. The method of claim 1, wherein joining comprises reactive joining.

23. An article, comprising:
a first component having a surface that comprises at least about 75% by volume of a refractory metal;
a second component comprising copper; and
a bonding material comprising a metallic material disposed between the first component and the second component; wherein the bonding material has a melting temperature lower than a melting temperature of the second component,
wherein the first component comprises a coating disposed on the surface of the first component, the coating comprising an adhesion layer comprising chromium and a wetting layer comprising nickel disposed over the adhesion layer.

24. The article of claim 23, wherein the metallic material comprises at least one of silver, gold, nickel, aluminum, copper, indium, titanium or zirconium.
